(19) United States
(12) Patent Application Publication
(10) Pub. No.: US 2002/0165025 A1
(43) Pub. Date: Nov. 7, 2002

(54) Service system for offering information of invitation of public contribution and/or prize contest by using cellular phone, personal digital assistants, computer terminal machine

(75) Inventor: Kazuhiro Kawahara, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Kabushiki-Kaisha Koubo-Guide-sha, Tokyo (JP)

(21) Appl. No.: 09/800,209

(22) Filed: Mar. 5, 2001

(30) Foreign Application Priority Data
Mar. 9, 2000 (JP) 2000-64451
Aug. 11, 2000 (JP) 2000-244174

(51) Int. Cl. G06F 19/00

(52) U.S. Cl. 463/41

(57) ABSTRACT

A service system offers information of an invitation of a public contribution and/or a prize contest by using a cellular phone, a personal digital assistant or a computer terminal machine. A user can easily participate in the system. The user is individually provided with proper information of the invitation of public contribution and/or the prize contest, and can apply for the information, by on-line registering basic information of the user through a cellular phone, a personal digital assistant, or a computer terminal machine connectable to the Internet, by carrying out a referring process on-line by using the proper information. The user is permitted access to a plurality of information of invitation of public contributions and/or prize contests on the Internet.

### OBJECT OF THE INVENTION

An object of the invention is to provide a new service system for offering information of invitation of public contribution and/or prize contest, which enables a user to easily receive and apply for the information of invitation of public contribution and/or prize contest by using a personal digital assistants such as a cellular phone or a computer terminal machine, a communication information amount of which has recently increased rapidly. A cellular phone should be considered to be one of personal digital assistants in a broad definition, but it is considered separately from personal digital assistants in this invention since what is focused on a communication function is often called a cellular phone, while a mobile type of computer terminal machine excellent in mobility other than the cellular phone is called a personal digital assistant.

### PRIOR ARTS

Conventionally, invitation of public contribution and/or prize contest by various companies or groups has been carried out widely, and usually a number of applications are performed profitably as well as interestingly. The applicant of the present invention has also issued printed matter such as magazines collecting information of invitation of public contribution and/or prize contest for a long time.

Application for such invitation of public contribution and/or prize contest is generally performed by post such as a post card, which meets a required condition. The information of invitation of public contribution and/or prize contest is, sometimes offered on-line through the Internet by using a computer as a communication terminal machine, for example, in accordance with the recent progress in the communication technology, but the application itself is often performed by post such as a post card. Even in the case that the on-line application is possible, there is usually a difference in manner in accordance with a type of invitation of public contribution and/or prize contest.

### PROBLEMS SOLVED BY THE INVENTION

In the conventional method described above, even in the case of getting a various kind of information of invitation of public contribution from the information of invitation of public contribution and/or prize contest, many of which appear as a whole in a magazine and such, or from a site in the Internet, it takes much cost for post when the application itself is performed by post such as a post card. The conventional method has a disadvantage that it is very troublesome to make a predetermined form of post cards in the case of performing a number of application.

Further, even in the case that the on-line application is possible by using the Internet, for example, the form of application is usually different for every company or group. Thus, even certain common data such as address, name, age, sex and telephone number of an applicant should be repeatedly inputted for application in the current situation. As for application especially for information of prize contest, it is often necessary to exclude overlapped applications from one person. In the application system using such as a post card, however, a trouble process is required such that a person should visually check the post cards or that a person should input the contents of the post cards into computer, for example, before excluding overlapped applications.

Recently, a personal digital assistant such as especially a cellular phone has been developed, and it is widely spread that the personal digital assistant is connected with the Internet for the purpose of sending various information data. There has never been provided a service, however, for offering information of invitation of public contribution and/or prize contest in a proper form, which is easy to use.

### MEANS FOR SOLVING THE PROBLEMS

The invention is created by repeated examination and study in relation to solving the above-mentioned problems in the prior art. According to the invention, a user can get information of invitation of public contribution and/or prize contest at any time by using a personal digital assistant such as a cellular phone, as well as an application for the various information of invitation of public contribution and/or prize contest can be easily performed on-line without using a system by post such as a post card, by registering basic information of the user. Concrete description is as follows:

(1) A service system for offering information of invitation of public contribution and/or prize contest by using cellular phone, a personal digital assistant, and a computer terminal machine, characterized in that a user can be permitted to easily participate in the system according to the invention, is individually provided with proper information of invitation of public contribution and/or prize contest correctly, and can apply for the information, by on-line registering basic information of a user through a cellular phone, a personal digital assistant, or a computer terminal machine connectable to the Internet, by carrying out a referring process on-line by using the basic information, and by permitting an access to a plurality of information of invitation of public contribution and/or prize contest on the Internet.

(2) The service system for offering information of invitation of public contribution and/or prize contest by using a cellular phone, a personal digital assistant, and a computer terminal machine according to the above paragraph (1), characterized in that an application procedure for the information of invitation of public contribution and/or prize contest is also able to performed on-line by using the basic information of the registered user

(3) The service system for offering information of invitation of public contribution and/or prize contest by using cellular phone, a personal digital assistant, and a computer terminal machine according to the above paragraph (1) or (2), characterized in that there is a charge for the offer of the information of invitation of public contribution and/or prize contest, the charge being paid together with a communication line using fee.

(4) The service system for offering information of invitation of public contribution and/or prize contest by using a cellular phone, a personal digital assistant, and a computer terminal machine according to one of the above paragraphs (1) to (3), characterized in that one or plurality of total number information of the application at an access time by a user or at a certain reference time, information of winning result of a past invitation of public contribution and/or prize contest, and result information of retrieving a winning result of the user is or are provided together with the invitation information of public contribution and/or prize contest as a part of the information of invitation of public contribution and/or prize contest.

(5) The service system for offering information of invitation of public contribution and/or prize contest by using a cellular phone, a personal digital assistant, and a computer terminal machine according to one of the paragraphs (1) to (4), characterized in that it is limited that only invitation information of public contribution and/or prize contest available to be applied for at the time of access by a user would be displayed in a cellular phone, a personal digital assistant, or a computer terminal machine connectable to the Internet.

(6) The service system for offering information of invitation of public contribution and/or prize contest by using a cellular phone, a personal digital assistant, and a computer terminal machine according to one of the above paragraphs (1) to (5), characterized in that offering the information of invitation of public contribution and/or prize contest and handling information of an application by a user are performed as a whole through a special controlling server.

(7) The service system for offering information of invitation of public contribution and/or prize contest by using a cellular phone, a personal digital assistant, and a computer terminal machine according to one of the above paragraphs (1) to (6), characterized in that a process for referring the basic information of the registered user can limit or permit overlapped applications by one user for the information of invitation of public contribution and/or prize contest in response to necessity.

(8) The service system for offering information of invitation of public contribution and/or prize contest by using a cellular phone, a personal digital assistant, and a computer terminal machine according to one of the above paragraph (1) to (7), characterized in that an applicant is required to reply a questionnaire accompanying an application for the information of invitation of public contribution and/or prize contest, and the reply, the basic information of the user, and the application data are given at any time to a provider of the information of invitation of public contribution and/or prize contest so as to be used as data for market research, product development, and sales promotion.

(9) The service system for offering information of invitation of public contribution and/or prize contest by using a cellular phone, a personal digital assistant, and a computer terminal machine according to one of the above paragraphs (1) to (8), characterized in that advertisement information from an advertising sponsor such as a provider of the information of invitation of public contribution and/or prize contest is also provided as information offered to a user, which accompanies the offer of the information of invitation of public contribution and/or prize contest.

(10) The service system for offering information of invitation of public contribution and/or prize contest by using a cellular phone, a personal digital assistant, and a computer terminal machine according to one of the above paragraphs (1) to (9), characterized in that information corresponding to an individual user is selected on the basis of the basic information of the user, the data of past applications, and the data of replies to a questionnaire so as to be provided to the individual user by an electronic mail.

### BRIEF DESCRIPTION OF THE DRAWINGS

FIG. 1 illustrates one example, which shows that “Basic information registration” was selected, of a top menu in the service system according to the invention, the top menu being displayed on a display screen of a personal digital assistant.

FIG. 2 illustrates a display screen in the case of setting basic information of a user in the service system according to the invention.

FIG. 3 illustrates an example of display on a screen, which from completion of the above basic information registration to charged registration.

FIG. 4 illustrates a process of performing the charged registration on a displaying screen of a cellular phone.

FIG. 5 illustrates a process of registering i-mode password on a displaying screen in an i-mode corresponding equipment.

FIG. 6 illustrates that “information of invitation of prize contest” is selected from the top menu in the system according to the invention.

FIG. 7 illustrates an example of a change of the picture in the case of retrieving the registered information of invitation of prize contest.

FIG. 8 illustrates an example of a change of the picture in the case of selecting “Application by i-mode” from the top menu in the system according to the invention.

FIG. 9 illustrates an example of a change of the picture in the case of selecting the application by i-mode for the concrete information of invitation of prize contest and inputting personal identification key data of the user to complete the application procedure.

FIG. 10 illustrates an example of a screen display in the case of performing various questionnaires accompanying the application procedure.

FIG. 11 is a chart illustrating a concept of a whole system according to the invention.

FIG. 12 illustrates an example in the case of displaying together related information such as advertisement information and campaign information of a provider of the information of invitation of public contribution and/or prize contest on a display screen of a terminal machine such as a cellular phone in which the invention is put into practice.

In the above-mentioned drawings, 1 denotes an icon indicating i-mode application, 2 denotes a display of related information such as an advertisement displayed together with the information of invitation of public contribution and/or prize contest, and 3 denotes an icon indicating completion of an application procedure.

### OPERATION

A user can be permitted to easily participate in the system according to the invention, is individually provided with proper information of invitation of public contribution and/or prize contest correctly, and can be permitted to apply for the information, by registering basic information of a user (information for certainly identifying an individual user in an on-line electronic process) through a cellular phone, a personal digital assistant, or a computer terminal machine connectable to the Internet, by permitting an access to information of invitation of public contribution and/or prize contest on the Internet through an on-line referring process by using the basic information, and by also receiving an application for the information.

It would be possible to collect a proper payment from a user in the system according to the invention by charging the user for the offer. Especially, the charge is paid with a communication line using fee so that the payment can be collected more conveniently and easily.

One or a plurality of total number information of the application at an access time by a user or at a certain reference time, information of winning result of a past invitation of public contribution and/or prize contest, and result information of retrieving a winning result of the user is or are provided together with the invitation information of public contribution and/or prize contest as a part of the information of invitation of public contribution and/or prize contest, so that the user would be able to easily get information useful for an application, for example, in response to the necessity and that participation by a user in the system according to the invention would be promoted.

The user can perform an application procedure for accessible information of invitation without taking a final expiry date of the invitation period into consideration by limiting so that only invitation information of public contribution and/or prize contest available to be applied for at the time of access by a user would be displayed on the display screen in a cellular phone, a personal digital assistant, or a computer terminal machine connectable to the Internet. Further, a provider of the information of invitation of public contribution and/or prize contest can handle as a whole the information, whose invitation period has passed, not to be accessed on a site, so that easy and convenient control of a period can be achieved.

Offering the information of invitation of public contribution and/or prize contest and handling information of application by a user are performed as a whole through a special controlling server, so that offer and control of information can be integrated and made to be rational with no waste. Especially, it would be easily to enable a user to perform an application procedure for a plurality of different information of invitation of public contribution and/or prize contest without inputting overlapped data by adopting integrated basic information of the user.

A process for referring the basic information of the registered user can limit or permit overlapped applications by one user for the information of invitation of public contribution and/or prize contest in response to necessity, so that a proper invitation condition of a provider of the information of invitation of public contribution and/or prize contest (such that overlapped applications are permitted for the information of invitation of public contribution, while they are not permitted for the information of prize contest, for example) can be met, and that it is prevented from occurring that the user loses his or her qualifications for an application due to overlapped applications performed by the user in error.

An applicant is required to reply to reply a questionnaire accompanying the application for the information of invitation of public contribution and/or prize contest, and the reply, the basic information of the user, and the application data are given at any time to a provider of the information of invitation of public contribution and/or prize contest so as to be used as data for market research, product development, and sales promotion, so that each field of product manufacturers and service providers can certainly get meaningful data in response to invitation of the public contribution and/or prize contest. Thus, the system can be beneficial for both of provider of the information of invitation of public contribution and/or prize contest and an applicant for the information.

Advertisement information (bargain information and discount coupon information, information concerning gift mail order, campaign information, monitor information and such) from such as a provider of the information of invitation of public contribution and/or prize contest is also provided as information offered to a user, which accompanies the offer of the information of invitation of public contribution and/or prize contest, so that it would be possible to display a proper advertisement information at a place easily focused on by a user, and thereby, to raise an advertising effect more than mere an advertisement on a site.

Information corresponding to an individual user is selected on the basis of the basic information of the user, the data of past applications, and the data of replies to a questionnaire so as to be provided to the individual user by an electronic mail, so that it would be possible to analyze attribute, hobby and taste of an individual user on the basis of accumulated data and that it would be possible to send intensively such as advertisement information, which appears to correspond to the user. Thus, a further elaborate service for offering information can be provided and a user can be enabled to get such as advertisement information having a high value.

### MODE FOR CARRYING OUT THE INVENTION

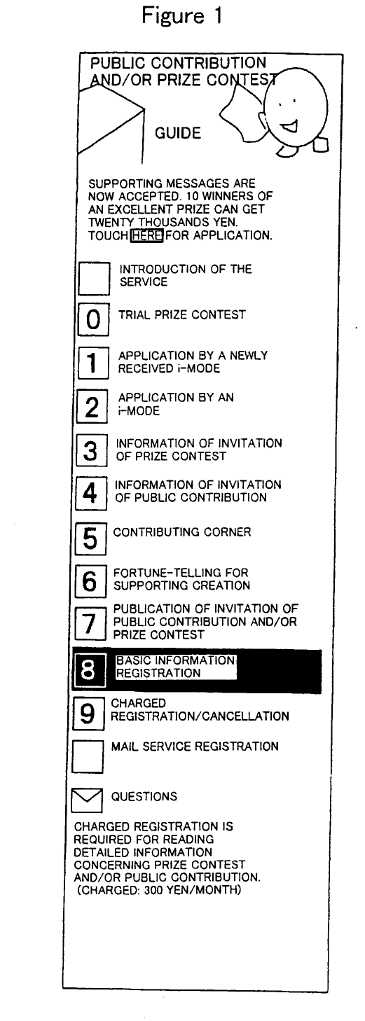

A typical embodiment of the invention mentioned above will be described in relation to the case of using cellular phone in accordance with attached drawings. That is, a user first selects “Basic information registration” from a picture of “Top menu” shown in FIG. 1 in a service system according to the invention to register a personal basic information of the user, although there may be a few differences among types of a personal digital assistant or a cellular phone in a process from an initial picture displayed on such a liquid crystal display of a personal digital assistant such as a cellular phone to the picture of “Top menu” of a service system for offering information of invitation of public contribution and/or prize contest according to the invention.

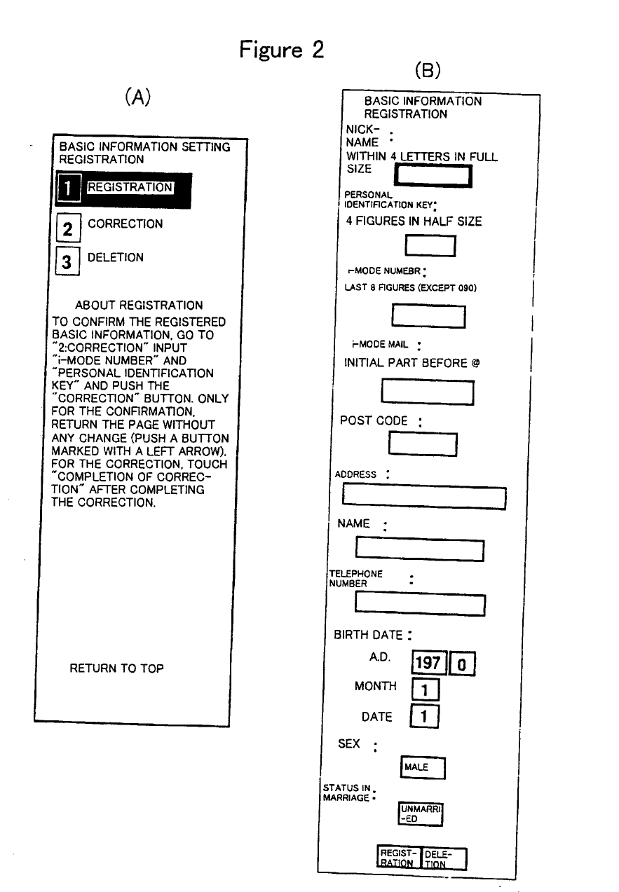

The picture goes to “Basic information setting” shown in FIG. 2 (A), after “Basic information registration” is selected. A user, who uses the system for the first time, selects “registration” here to go to a process for registering concrete basic information, while he or she can select at the same time “Change” or “Deletion” of the basic information, which has been already registered, in the above picture of “Basic information setting”. The picture goes to “Basic information registration” shown in FIG. 2(B) when the user selects the above “Registration”. The user should input here data such as personal information shown in the figure, optionally selected “Nickname”, and “Personal identification key” in proper manner in order to participate in the service system according to the invention, and then, select “Registration” after completing the input of required items. It is possible to select “Deletion” when the user wants to delete all of the inputted contents. “Basic information” according to the invention means the information for distinctly identifying in an on-line process a user to be provided with the service according to the invention, and the information that must be registered in advance so that sending of a prize, which is won in a prize contest, can be performed correctly, for example. Concretely, “Basic information” is the information of nickname, personal identification key, i-mode number, mail address, post code, address, name, telephone number, data of birth, sex, married/unmarried and such shown in FIG. 2(B). All of these items are not necessary required, of course, and it is possible to require only requisite information for operating the system according to the invention.

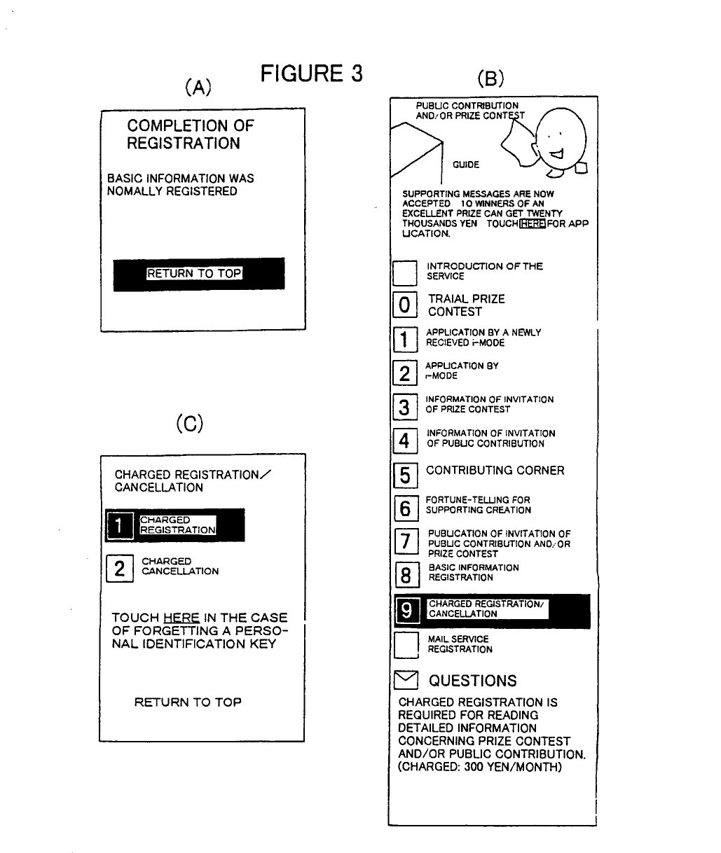

After the above “Registration” is formally completed, the picture goes to “Completion of registration” as shown in FIG. 3(A), so that the user can confirm that the registration has been formally completed. The picture goes back to “Top menu” shown in FIG. 3(B) or 1, in the case that “Return to Top” is selected. At the completion of a process until here, the basic information of an individual user has been registered for participating the service system for offering information of invitation of public contribution and/or prize contest according to the invention, and it is possible to enable the user at this stage to apply for a “Trial prize contest”, which is free information available. It is also possible to use the space for displaying such information concerning a free service as a space for displaying advertising information from a provider of the information of invitation of public contribution and/or prize contest in response to a request from the provider.

The user who has been completed the registration of the basic information can be provided with information such as the above free information “Trial prize contest” for the purpose of complete understanding of the system according to the invention by a user who uses the system for the first time, for example, although the main information of invitation of public contribution and/or prize contest provided in accordance with the invention is charged. The user completely understanding the service system according to the invention by such as “Trail prize contest” or “Introduction of the service” and further agreeing to receive the charged information of invitation of public contribution and/or prize contest selects the “Charged registration/Cancel” shown in FIG. 3(B) to move the picture to the “Charged registration/Cancel” shown in FIG. 3(C). “Charged cancellation” would be selected here in the case that the user who has already completed the charged registration cancels the charged registration, while the user newly performing the charged registration should select “Charged registration”.

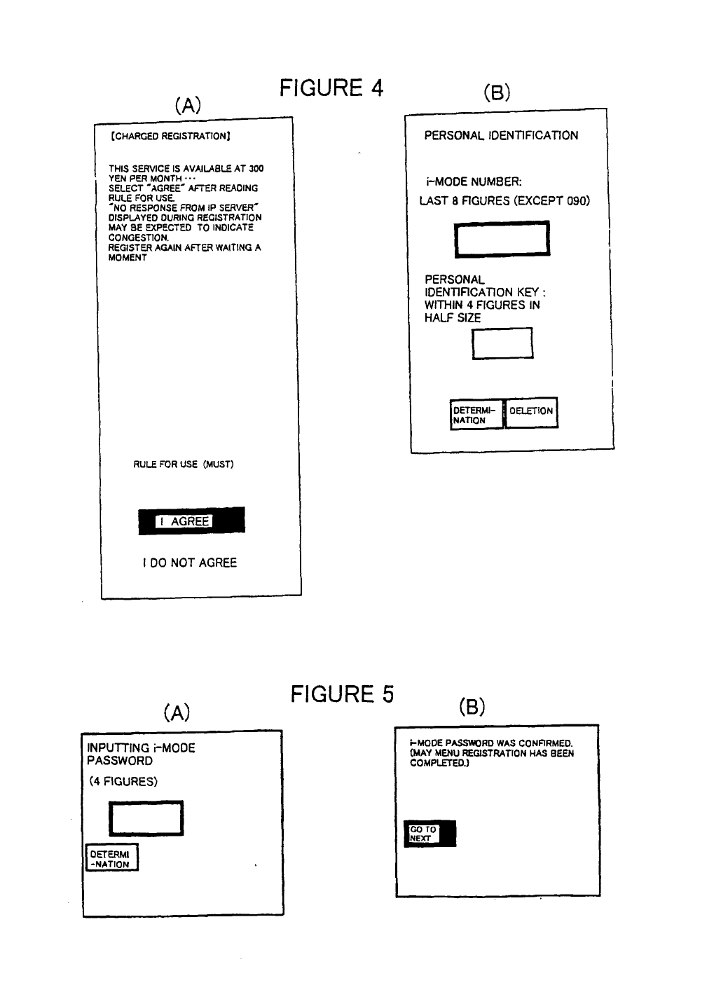

After “Charged registration” is selected, the picture goes to “Charged registration” shown in FIG. 4(A). The user agreeing to a rule for use, which is shown in the above picture, selects “Agree” to move to the picture “Personal identification” shown in FIG. 4(B), and then, input again personal identification data shown in the figure so as to perform charging registration. When “Determination” is selected here after the inputted data is confirmed, it goes to a picture of confirmation of basic information inputting data again. Selecting “Charged registration” after confirming that there is no error in the contents completes “Charged registration” in the service system according to the invention.

In the case of a personal digital assistant capable of offering a service in a so-called “i-mode” manner, it goes to a picture of inputting “i-mode password” shown in FIG. 5(A) following to the above “Charged registration”, and then, the above picture changes to the picture of “Confirmation” shown in FIG. 5(B) when the user inputs the above password and select “Determination”. At the same time, the registration to “My menu” in the “i-mode” service is performed, and thus, selecting the service according to the invention among the items registered in the above “My menu” enables the user to move from the initial picture of the above personal digital assistant to “Top menu” of the service according to the invention easily.

Payment for the offer of the charged information in the service system according to the invention is carried out in a manner of charging together with a communication fee of such a cellular phone. Any manner can be adopted, however, as far as the manner is technically possible and security of the manner is confirmed, such as clearing by means of a credit card or prepaid card and on-line electronic money clearing. The amount of payment for the offer of the charged information according to the invention is comparatively small (around 300 yen per a month), so that it hardly appears that the user would be significantly damaged by unlawful clearing procedure.

The above user who has completed the charged registration can use the basic information, which has been already registered and which is stored in a terminal machine such as the user's cellular phone, to move to the picture of “Top menu” in the service system according to the invention automatically or after the reference/confirmation of inputted data such as “code number”, “personal password” and “i-mode password”, which are related to the basic information, and can get all information shown in the above picture. It is preferable that the inviting method of the information of public contribution and/or prize contest offered in accordance with the invention would be offered separately between a method by post such as a post card and a method in which a personal digital assistant such as a cellular phone can be used as it is for an application.

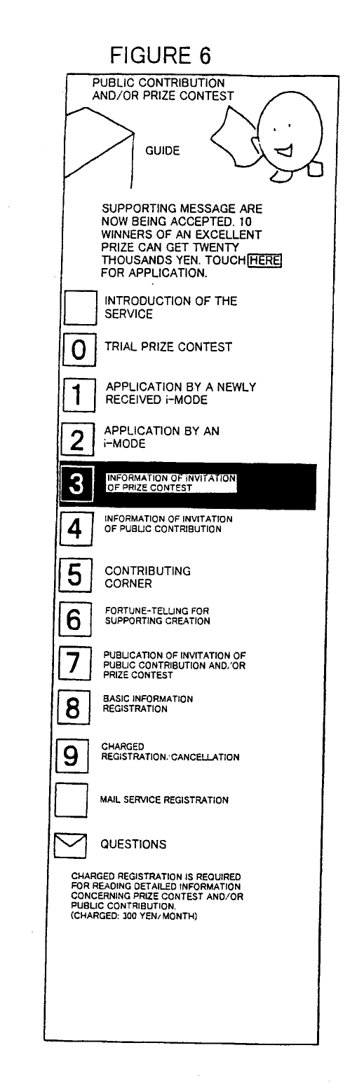

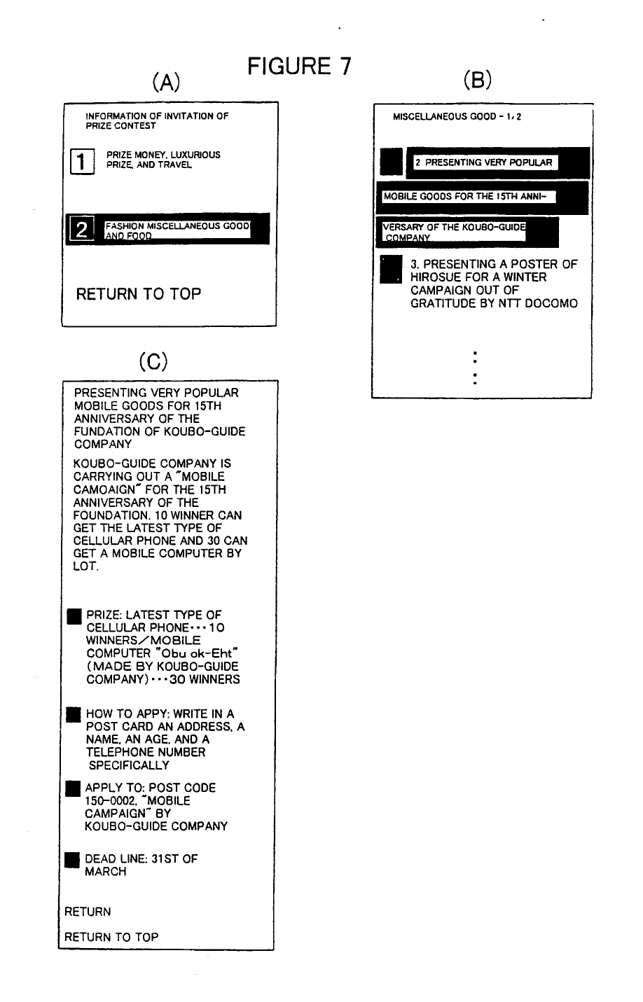

First, the case of offering the information of public contribution and/or prize contest, which is applied for by post will be described. When “Information of invitation of prize contest” is selected from the picture of “Top menu” as shown in FIG. 6, the picture moves to “Information of invitation of prize contest” shown in FIG. 7(A). In this picture, the offered information of invitation of prize contest is classified by subjects as shown in the figure. When “Fashion, Miscellaneous Good, and Food” is selected, it goes to the picture shown in FIG. 7(B) to show individual and concrete information of invitation of prize contest in the subject. After the user selects an item of the individual and concrete information of invitation of prize contest that he or she wants to apply for, the information of invitation of prize contest is displayed in detail as shown in FIG. 7(C). The user proceeds with application by post such as a post card in accordance with the displayed information such as prize, the number of winners, application method, address for application and deadline.

In the above case, however, application is performed by post, which cannot give benefit of the information communication technology recently developing rapidly, though it is sure that the information of invitation of public contribution and/or prize contest itself can be available easily compared with the prior art method. Accordingly, the invention also proposes to use a personal digital assistant (such as a cellular phone) so that the personal digital assistant also can perform an application.

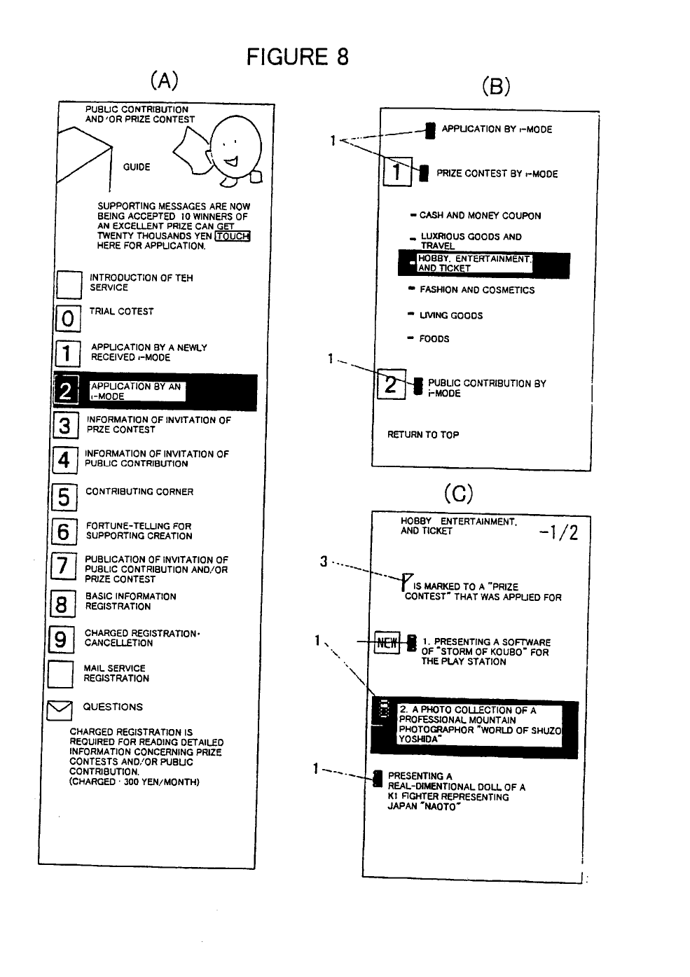

That is, in accordance with an example shown in the figures, when “Application by i-mode” is selected from “Top menu” in the system according to the invention shown in FIG. 8(A), the picture shown in FIG. 8(B) moves to that of FIG. 8(C) so as to show the information of invitation of public contribution and/or prize contest, which can be applied for by means of a cellular phone, all at once. Such information may also be displayed of the basis of subject, of course. It is preferable that a particular icon 1, as shown in FIGS. 8(A) to (C), is displayed for the information of invitation of public contribution and/or prize contest available to be applied for by means of “i-mode” so that the user can definitely recognize such information of invitation of public contribution and/or prize contest. As for the information of invitation of public contribution and/or prize contest whose application has been concluded, an icon 3 indicating the conclusion is displayed so that the user can recognize it correctly.

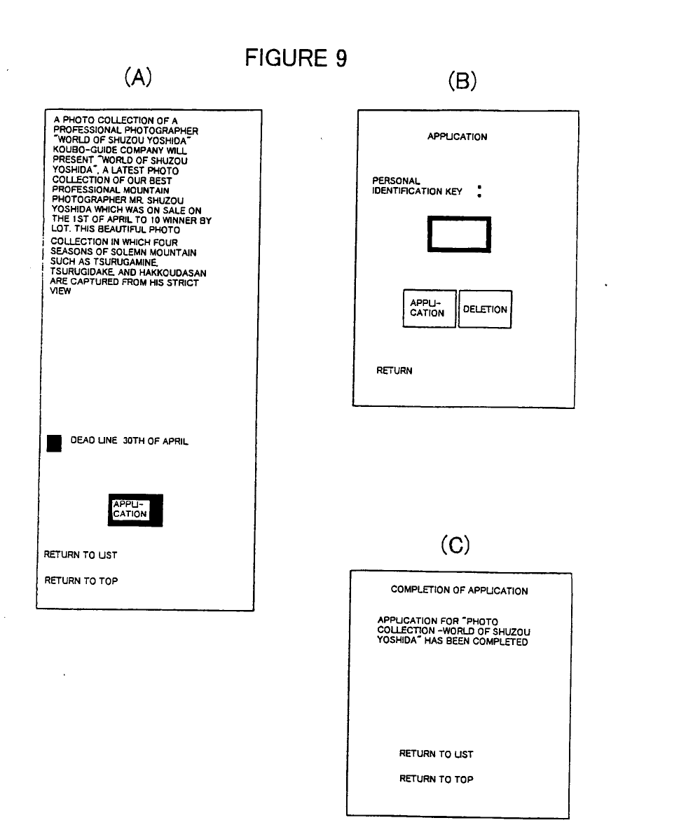

When any information of invitation of public contribution and/or prize contest is selected from a list of the information on the above picture, its detail is displayed as shown in FIG. 9(A), and then, the picture goes to “Application” shown in FIG. 9(B) after the contents are confirmed and “Application” is selected. Here, the data of “Personal Identification Key” which is registered as basic information of a user, is inputted into a predetermined place. After that, selecting an “Application” button and confirming that there is no error complete the application procedure through a process for referring to the data of “Personal identification key”, so that the picture goes to “Completion of Application” shown in FIG. 9(C). That is, the user can easily complete an application procedure on the basis of the registered basic information by using the data of “Personal identification key”, which is registered as the basic information, and also can complete an application procedure such that there is no comparison with the application by post in ease and speed. The case of using so-called “i-mode” manner was described above, but other than the above, any manner can be adopted as well, as far as it is possible to use a personal digital assistant (cellular phone) to connect the Internet for exchanging data.

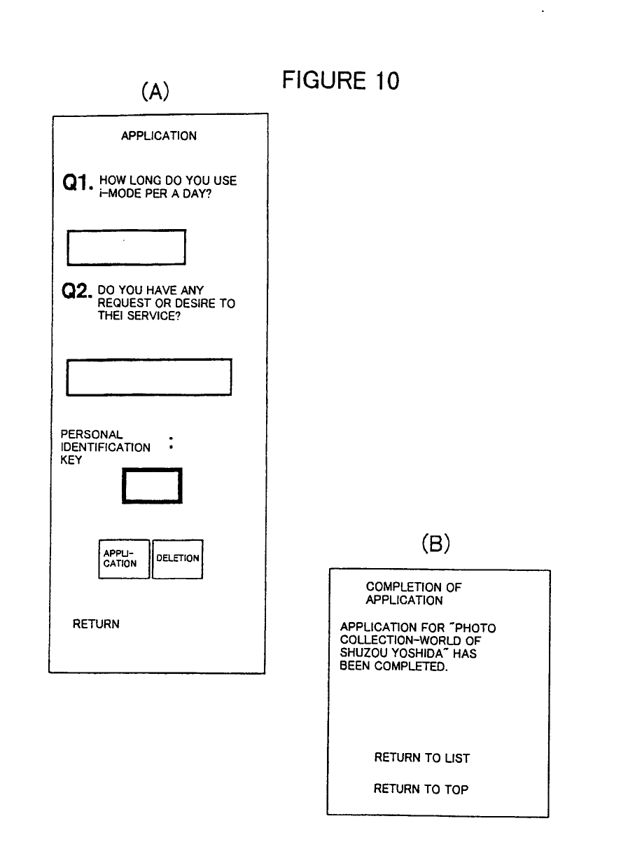

In the case of carrying out an application procedure for the information of invitation of public contribution and/or prize contest by means of a personal digital assistant (cellular phone) as described above, it is also possible to collect replies to a various kind of questionnaires accompanying the above application procedure. That is, it is possible to send a few questionnaires to the applicant as shown in FIG. 10(A) so that the applicant would perform the application procedure including the reply to the questionnaires. In this case, inputting the personal identification key data together with the reply to the questionnaires and selecting the application button completes the application procedure, and the picture goes to “Completion of Application” shown in FIG. 10(B). A provider of such as information of invitation of public contribution and/or prize contest can get data meaningful for market research or product development by receiving also the aforementioned replies to the questionnaires. It means that offering the information of invitation of public contribution and/or prize contest can achieve a successful effect such as sales promotion.

Further, the data sent in the “Application” process are performed in digital by means of a personal digital assistant in both cases of an application for the information of invitation of public contribution and/or prize contest and of a reply for accompanied questionnaires Thus, it is clear that a provider of the information of invitation of public contribution and/or prize contest can easily determine its winner and can easily process the data of replies to the questionnaires by a computer or such in totaling the replies. Data storing and controlling after the totaling also would be able to be easy and in this point, an easier, more convenient, and quicker operation can be achieved compared with application by such as a post card.

In the service system for offering information of invitation of public contribution and/or prize contest according to the invention, not only the above-described information of invitation of public contribution and/or prize contest and an application procedure for the information but also information accompanying the above can be offered together to a user That is, setting an item such as “Publication of Invitation of Public Contribution and/or Prize Contest” in the picture of “Top menu” in the system according to the invention shown in, for example, FIG. 6 so that the item would be selected by the user enables publication of the data of a result and/or a work, which won a prize, or of the data such as total number of application as for the information of invitation of public contribution and/or prize contest, for which the user is applying, at an access time or at a specific reference time even during the access time, in relation to the information of invitation of public contribution and/or prize contest offered in the system according to the invention. It is possible to enable a user to check whether a specific user who is referred to and confirmed by the personal identification key data in relation to each kind of information of invitation of public contribution and/or prize contest won a prize or not, since the user inputs the own personal identification key data to access the above data. Given the total number of application in relation to the information of invitation of public contribution and/or prize contest, which is being invited, the user can make a reference to it in performing a practical application procedure. Thus, it is expected that offering such information concerned would promote much more active application.

It is preferable that offering information of invitation of public contribution and/or prize contest in the system according to the invention is controlled as a whole through such as a special controlling server. It is required to build a system for controlling the information to be offered, the data of application and such so that they would not be confused even in the case that the offer is performed through such as a plurality of servers. Accordingly, the information of invitation of public contribution and/or prize contest offered in the system according to the invention can be limited to be offered to the information, which is inviting the above at the time of access by a user, since offering of the information of invitation of public contribution and/or prize contest is controlled as a whole as described above. By limiting the offered information, the user can recognize that the offered information is information available for application especially when the “application” procedure is also performed by means of a personal digital assistant, and as a result, the user do not have care about limitation such as application period. A provider of the information of invitation of public contribution and/or prize contest also does not have to offer information in vain by updating information to be offered at any time. It is of course possible to handle the information of invitation of public contribution and/or prize contest, whose application period has been past, as data available to be selected for reading from items such as the aforementioned “Publication of Public Contribution and/or Prize Contest”, for a user who wants to know the past information of invitation of public contribution and/or prize contest.

It is sometime no problem to receive a plurality of applications for the information of prize contest from one person, but it is sometime inconvenient for determining a winner and for totaling data upon receiving a plurality of application for the information of invitation of public contribution and a plurality of replies to accompanying questionnaires from one person. In the latter case, application and/or reply from one person should be limited not to be overlapped. In the system according to the invention, however, overlapped applications and/or overlapped replies can be easily excluded since the basic information of a user having performed an application and/or a reply has been registered. Therefore, an operation would be achieved easily, conveniently, and quickly for receiving or excluding overlapped applications and/or replies from one user in accordance with invention content of the information of invitation of public contribution and/or prize contest.

Moreover, an advertisement of a product or a service of a product manufacturer or service company, which is a provider of the information of invitation of public contribution and/or prize contest, and information of invitation of a campaign or a monitor are displayed as the information, which would be offered to the user together with the information of invitation of public contribution and/or prize contest, on a picture for offering or applying for the information of invitation of public contribution and/or prize contest together with the information of invitation of public contribution and/or prize contest. Then, as described above, it would be possible to offer information of every kind of advertisement at a place where a user, who focuses on the information of invitation of public contribution and/or prize contest so as to apply for it, highly appears to recognize it as information having a close relation and to focus on it with a certain interesting. Thus, this service can be a support service system having a large advertisement effect and a large marketing effect for a provider of the information of invitation of public contribution and/or prize contest.

It is further possible to analyze data such as user's purchase will, purchase price level, hobby and taste for a product or a service on the basis of such as user's registered basic information, past application data, and data of reply to a questionnaire so that advertisement information and such, which appear to be proper for an individual user, can be selected and provided as a electronic mail providing service for an individual user. Therefore, an actual effectiveness would be larger than an electronic mail providing service like a mere direct mail.

The above description is for the case of using a cellular phone (such as a type corresponding to the i-mode) having a function for connecting to the Internet. It is possible, however, to adopt the system according to the invention even in a so-called personal digital assistant (such as a palm-top type computer terminal equipment) as far as they have a communication function to connect to the Internet. It is also possible to bring the system according to the invention into practice in a usual desktop type computer terminal equipment except for an advantage in portability.

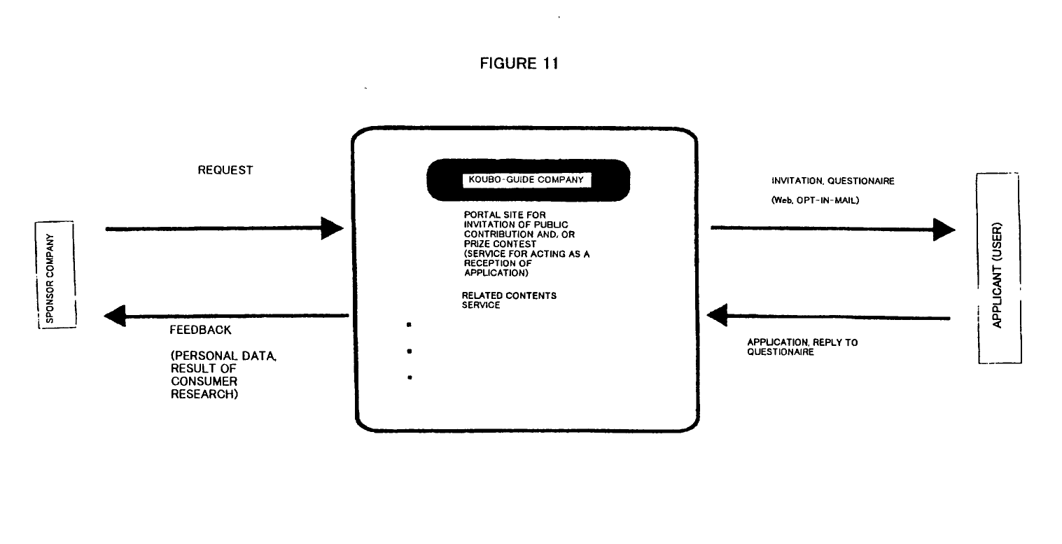

FIG. 11 shows conceptually a whole system according to the invention described above. That is, in the system according to the invention, a provider of a system according to the invention (such as an applicant of the invention), who has received a request from such as a sponsor company in relation to offering of the information of invitation of public contribution and/or prize contest, straightens and processes the information of invitation of public contribution and/or prize contest to publish it on the Internet so that it would be accessible through every kind of personal digital assistants, a user having registered basic information can access to the above information at any time to perform even an application procedure through the Internet by means of each terminal machine, and related information and questionnaires accompanying the offer of the information of invitation of public contribution and/or prize contest, advertisement to an individual user by an electronic mail, and such can be provided so that responses to them would be given to a sponsor company to its advantage

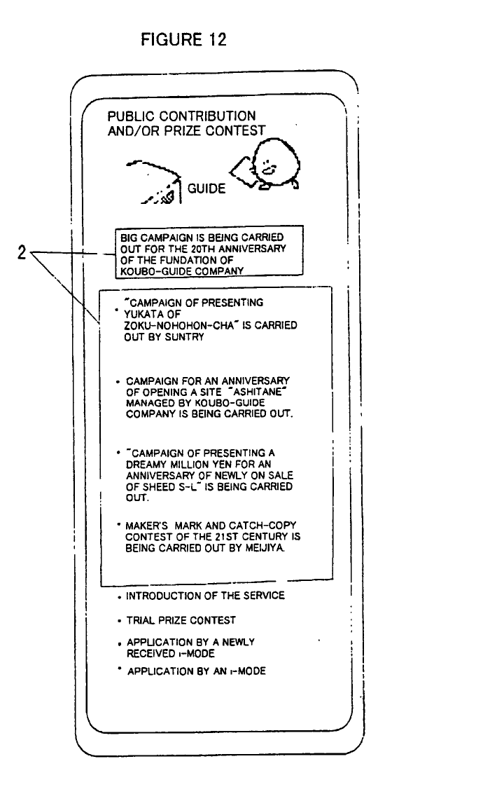

FIG. 12 shows an example in the case of displaying together a display 2 of related information such as advertisement information and campaign information of a provider of the information of invitation of public contribution and/or prize contest on a display screen of a terminal machine such as a cellular phone in which the invention is put into practice. Such related information itself may be made selectable so that the selection by a user would move the picture to display further detail information. In this arrangement, it is enough to initially display a catch-copy or its equivalent as related information such as an advertisement.

### EFFECT OF THE INVENTION

According to the invention described above, it is possible to use basic information of an individual user registered by means of a personal digital assistant so that the user can easily access to a number of information of invitation of public contribution and/or prize contest offered through the Internet, and to enable the user to perform an application procedure for the above information of invitation also by means of the above personal digital assistant. Further, it would be possible to easily handle the offer of related peripheral information, a questionnaire and a reply thereto as digital information capable of various processes such as totaling and editing. Moreover, it is possible to provide at any time such as advertisement information corresponding to the individual user by means of an electronic mail function. The invention gives respective advantages for both of a provider of the information of invitation of public contribution and/or prize contest and a user, and thus, it has industrially a high value.

We claim,

1. A service system for offering information of invitation of public contribution and/or prize contest by using a cellular phone, a personal digital assistant, and a computer terminal machine, characterized in that a user can be permitted to easily participate in the system according to the invention, is individually provided with proper information of invitation of public contribution and/or prize contest correctly, and can apply for the information, by on-line registering basic information of the user through a cellular phone, a personal digital assistant, or a computer terminal machine connectable to the Internet, by carrying out a referring process on-line by using the basic information, and by permitting an access to a plurality of information of invitation of public contribution and/or prize contest on the Internet.

2. The service system for offering information of invitation of public contribution and/or prize contest by using a cellular phone, a personal digital assistant, and a computer terminal machine according to claim 1, characterized in that a application procedure for the information of public contribution and/or prize contest is also able to be performed on-line by using the basic information of the registered user.

3. The service system for offering information of invitation of public contribution and/or prize contest by using a cellular phone, a personal digital assistant, and a computer terminal machine according to claim 1 or 2, characterized in that there is a charge for the offer of the information of invitation of public contribution and/or prize contest, the charge being paid together with a communication line using fee.

4. The service system for offering information of invitation of public contribution and/or prize contest by using a cellular phone, a personal digital assistant, and a computer terminal machine according to one of claims 1 to 3, characterized in that one or a plurality of total number information of the application at an access time by a user or at a certain reference time, information of winning result of a past invitation of public contribution and/or prize contest, and result information of retrieving a winning result of the user is or are provided together with the invitation information of public contribution and/or prize contest as a part of the information of invitation of public contribution and/or prize contest.

5. The service system for offering information of invitation of public contribution and/or prize contest by using a cellular phone, a personal digital assistant, and a computer terminal machine according to one of claims 1 to 4, characterized in that it is limited that only invitation information of public contribution and/or prize contest available to be applied for at the time of access by a user would be displayed in a cellular phone, a personal digital assistant, or a computer terminal machine connectable to the Internet.

6. The service system for offering information of invitation of public contribution and/or prize contest by using a cellular phone, a personal digital assistant, and a computer terminal machine according to one of claims 1 to 5, characterized in that offering the information of invitation of public contribution and/or prize contest and handling information of an application by a user are performed as a whole through a special controlling server.

7. The service system for offering information of invitation of public contribution and/or prize contest by using a cellular phone, a personal digital assistant, and a computer terminal machine according to one of claims 1 to 6, characterized in that a process for referring the basic information of the registered user can limit or permit overlapped application by one user for the information of invitation of public contribution and/or prize contest in response to necessity.

8. The service system for offering information of invitation of public contribution and/or prize contest by using a cellular phone, a personal digital assistant, and a computer terminal machine according to one of claims 1 to 7, characterized in that an applicant is required to reply a questionnaire accompanying an application for the information of invitation of public contribution and/or prize contest, and the reply, the basic information of the user, and the application data are given at any time to a provider of the information of invitation of public contribution and/or prize contest so as to be used as data for market research, product development, and sales promotion.

9. The service system for offering information of invitation of public contribution and/or prize contest by using a cellular phone, a personal digital assistant, and a computer terminal machine according to one of claims 1 to 8, characterized in that advertisement information from an advertising sponsor such as a provider of the information of invitation of public contribution and/or prize contest is also provided as information offered to a user, which accompanies the offer of the information of invitation of public contribution and/or prize contest.

10. The service system for offering information of invitation of public contribution and/or prize contest by using a cellular phone, a personal digital assistant, and a computer terminal machine according to one of claims 1 to 9, characterized in that information corresponding to an individual user is selected on the basis of the basic information of the user, the data of past applications, and the data of replies to a questionnaires so as to be provided to the individual user by an electronic mail.
